(19) United States
(12) Patent Application Publication
(10) Pub. No.: US 2010/0242743 A1
(43) Pub. Date: Sep. 30, 2010

(54) PASTRY PRODUCING APPARATUS AND PASTRY PRODUCING LINE

(75) Inventors: Shigeru Hashimoto, Tochigi (JP); Yasunori Kondo, Tochigi (JP)

Correspondence Address: GREENBLUM & BERNSTEIN, P.L.C., 1950 ROLAND CLARKE PLACE, RESTON, VA, 20191, US

(73) Assignee: RHEON AUTOMATIC MACHINERY CO., LTD., Tochigi (JP)

(21) Appl. No.: 12/680,816

(22) PCT Filed: Sep. 2, 2008
(86) PCT No.: PCT/JP2008/065735

§ 371 Date: May 25, 2010

(30) Foreign Application Priority Data
Oct. 4, 2007 (JP) 2007-261377

(51) Int. Cl. A21C 9/00; A47J 43/00

(52) U.S. Cl. 99/450.1; 99/537

(57) ABSTRACT

A pastry producing apparatus (3) produces a pastry in which overlying dough (53) is placed on core dough (15). On a downstream side of the pastry producing apparatus (3), an upper curved surface forming apparatus (5) presses the overlying dough against the core dough, thereby forms the overlying dough and the core dough integrally with each other. On a downstream side of the upper curved surface forming apparatus (5), a shaping apparatus (7) horizontally moves such a pastry formed by the upper curved surface forming apparatus (5), and performs a shaping action for the pastry. Moreover, on a downstream side of the shaping apparatus (7), an imprinting apparatus (9) presses a template against an upper portion of the pastry subjected to the shaping action by the shaping apparatus (7), and imprints, to the upper portion, an appropriate groove-shaped pattern provided in the template. The pastry producing apparatus (3) composes one unit (U1). The upper curved surface forming apparatus (5), the shaping apparatus (7) and the imprinting apparatus (9) compose another unit (U2) in combination with one another.

### TECHNICAL FIELD

The present invention relates to a pastry producing apparatus for producing a pastry such as a concha (pastry said to be an origin of a melonpan) known as Mexican pastry, in which flat (sheet-shaped) second food dough called overlying dough, cover dough or the like is placed on first food dough such as bread dough, and relates to a pastry producing line using the pastry producing apparatus.

### BACKGROUND ART

For example, a pastry such as a concha and a melonpan is produced in such a manner that flat overlying dough is placed on hemispherical core dough, and the above-described core dough and overlying dough are integrated with each other, and are subjected as a product to finish forming (shaping) (refer to patent literature PTL 1).

### CITATION LIST

### Patent Literature

### [PTL 1] Japanese Patent No. 3557259

### SUMMARY OF INVENTION

A description will be made below of a configuration described in the foregoing Patent Literature PTL 1. First, core dough cut into a mass in advance is rounded into a spherical shape in a forming step. Thereafter, the core dough is conveyed to the next step, where overlying dough formed into a flat shape is placed thereon. Here, with regard to the above-described overlying dough, after overlying dough cut into a mass in advance is formed into the flat shape, the overlying dough is conveyed to a conveyor line of the above-described core dough, and is placed on the core dough. Hence, the configuration described in Patent Literature PTL 1 is a configuration in which a forming line of the core dough and a forming line of the overlying dough intersect each other. Therefore, there have been problems that a scale of the entire line configuration becomes large, and that an area possessed by the configuration becomes large.

In this connection, in consideration of the foregoing circumstances, it is an object of the present invention to provide a pastry producing apparatus capable of easily producing the pastry, for example, such as the concha and the melonpan, which is in a state where the overlying dough is placed on the core dough, and to provide a pastry producing line that achieves miniaturization of the entire configuration thereof by using the pastry producing apparatus.

A pastry producing apparatus according to a first aspect of the present invention is a pastry producing apparatus for producing a pastry that is in a state where overlying dough is placed on core dough, including: a core dough cutting apparatus for cutting first food dough into core dough with a desired shape; a core dough conveying apparatus that is vertically movable in order to receive the core dough and is capable of freely conveying the core dough to a downstream side; an overlying dough supply apparatus provided adjacent to the core dough cutting apparatus in order to place the flat overlying dough as second food dough on the core dough conveyed by the core dough conveying apparatus; and an operation controller for controlling an overlying dough supply operation of the overlying dough supply apparatus operating in relation to a cutting operation of the core dough cutting apparatus and vertical and conveying operations of the core dough conveying apparatus.

It is preferable that the overlying dough supply apparatus rotatably include a rotary valve capable of adjusting a discharge width of the overlying dough in a casing including a slit-shaped opening portion for forming, into a flat shape, the second food dough fed with pressure from a food dough supply section supplying the second food dough, the overlying dough discharged from the opening portion.

It is preferable that the rotary valve include a receiving opening portion for receiving the second food dough fed with pressure from the food dough supply section in a part of a circumferential surface of a valve body, and include an outlet opening portion for guiding the food dough to the slit-shaped opening portion side in a part of the circumferential surface of the valve body. At the same time, it is preferable that the outlet opening portion include an opening edge having a curved edge in which a dimension in a circumferential direction from a virtual reference position on the circumferential surface, the virtual reference position being parallel to an axial center of the valve body, becomes gradually shorter toward both end sides in a longitudinal direction of the valve body from a center portion side in the longitudinal direction, or that the outlet opening portion include an opening edge with a trapezoidal shape.

It is preferable that timing when the food dough supply section starts to feed the second food dough with pressure and timing when the rotary valve opens the slit-shaped opening portion be substantially the same.

Moreover, a pastry producing line using the pastry producing apparatus according to the first aspect of the present invention includes: the pastry producing apparatus; an upper curved surface forming apparatus for pressing the overlying dough against the core dough, thereby forming the overlying dough and the core dough integrally with each other, and forming an upper surface of a pastry into a curved surface shape, the upper curved surface forming apparatus provided on a downstream side of the pastry producing apparatus; a shaping apparatus for horizontally moving the pastry in which the upper surface is formed into the curved surface shape by the upper curved surface forming apparatus, and performing a shaping action for the pastry, the shaping apparatus provided on a downstream side of the upper curved surface forming apparatus; and an imprinting apparatus for pressing a template against an upper portion of the pastry subjected to the shaping action by the shaping apparatus, and imprinting, to the upper portion, an appropriate groove-shaped pattern provided in the template, the imprinting apparatus provided on a downstream side of the shaping apparatus.

It is preferable that the imprinting apparatus include a plurality of air jets which jet air into an inner surface of the template in order to peel off the pastry from the template.

It is preferable that the template provided in the imprinting apparatus have a configuration that is urged by a plurality of urging devices so as to hold a basic posture, and is swingable at a time of pressing the pastry.

Moreover, the pastry producing apparatus can be composed as one unit, and the upper curved surface forming apparatus, the shaping apparatus and the imprinting apparatus can be composed as one unit in combination with one another.

In accordance with the pastry producing apparatus according to the first aspect of the present invention, the pastry that in the state where the overlying dough is placed on the core dough is automatically produced. Therefore, the pastry producing apparatus can easily cope with such small amount production in which a shaping step as a subsequent step is performed by handwork. Moreover, when automation is attempted by composing a production line, a configuration in which the respective units are arranged in the production line is established. Therefore, it is easy to incorporate the pastry producing apparatus in the production line, and area reduction of the pastry producing line is achieved.

### BRIEF DESCRIPTION OF DRAWINGS

FIG. 1 A front explanatory view of a pastry producing line.

FIG. 2 A plan explanatory view of the pastry producing line.

FIG. 3 A front cross-sectional explanatory view showing a principal portion of a pastry producing apparatus.

FIG. 4 A plan cross-sectional explanatory view showing the principal portion of the pastry producing apparatus.

FIG. 5 Explanatory illustrations showing a configuration of a rotary valve portion in a sheet-shaped food dough discharge apparatus.

FIG. 6 Explanatory illustrations of an action to discharge sheet-shaped food dough.

FIG. 7 A cross-sectional explanatory view of an upper curved surface forming apparatus.

FIG. 8 A cross-sectional explanatory view of an imprinting apparatus.

### DESCRIPTION OF EMBODIMENTS

A description will be made below of embodiments of the present invention by using the drawings.

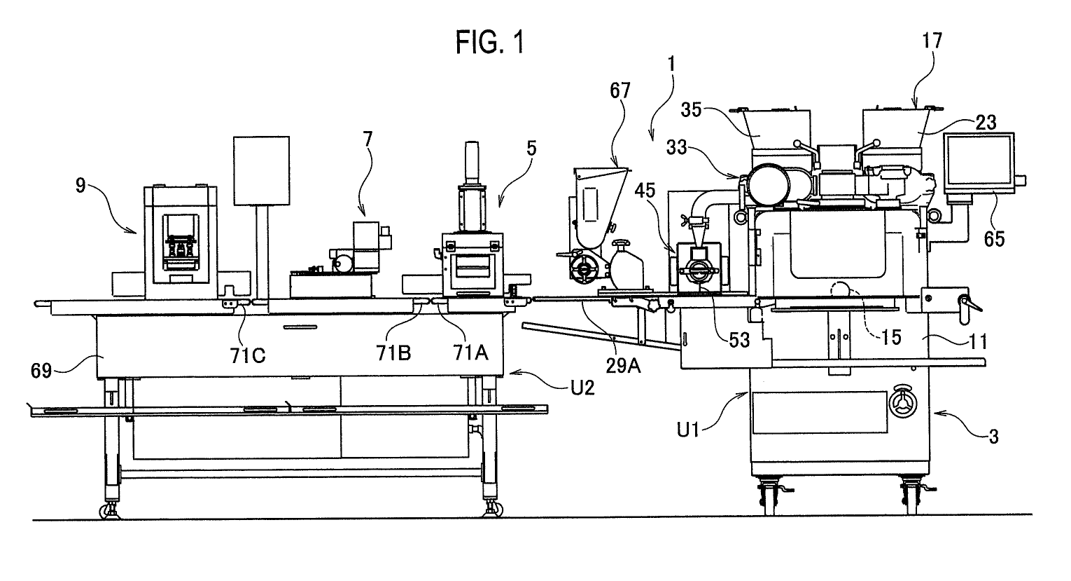

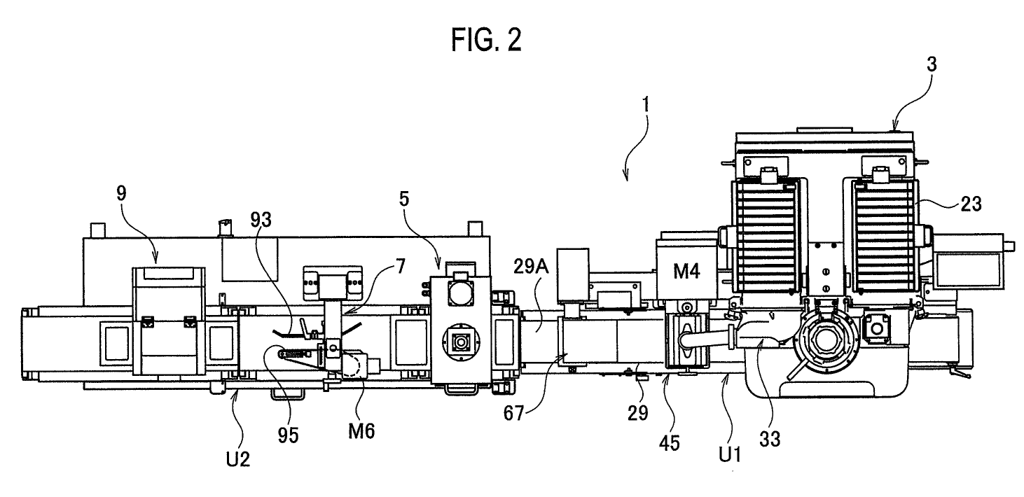

FIGS. 1 and 2 show a pastry producing line 1 for producing a pastry such as a concha (type of a melonpan). This pastry production line 1 is composed of two units, which are a unit U1 and a unit U2. First, the unit U1 cuts first food dough such as bread dough into core dough with a desired shape, for example, a spherical shape and a long bar shape (for example, an elliptical and mound shape like that of a hot dog bun). Next, the unit U1 places flat (sheet-shaped) second food dough called overlying dough, cover dough or the like on the core dough. The unit U1 composes, as one unit, a pastry producing apparatus 3 for producing the pastry that is in a state where the flat second food dough is placed on the core dough as described above.

Then, the unit U2 is installed on a downstream side of the above-described pastry producing apparatus 3. This unit U2 combines, with one another: an upper curved surface forming apparatus 5 for forming an upper surface of the pastry into a curved surface shape; a shaping apparatus 7 for horizontally moving the pastry (cake product), in which the upper surface is formed into the curved surface shape by the upper curved surface forming apparatus 5, and performing a shaping action for the pastry concerned; and an imprinting apparatus 9 for imprinting a groove-shaped pattern such as a mesh pattern to an upper portion of the pastry subjected to the shaping action by the above-described shaping apparatus 7. In such a way, the unit U2 composes one unit.

The first unit U1 on an upstream side and the second unit U2 on the downstream side are assembled and adjusted separately from each other. Thereafter, the units U1 and U2 are transported to a factory separately from each other. Then, both of the units U1 and U2 are arranged and adjusted as the pastry producing line in the factory. Moreover, each of the units U1 and U2 is formed by unitization and combination of a plurality of apparatuses, and an arrangement relationship between both of the units U1 and U2 can be densified. From this matter, the entire configuration of the pastry producing line is miniaturized.

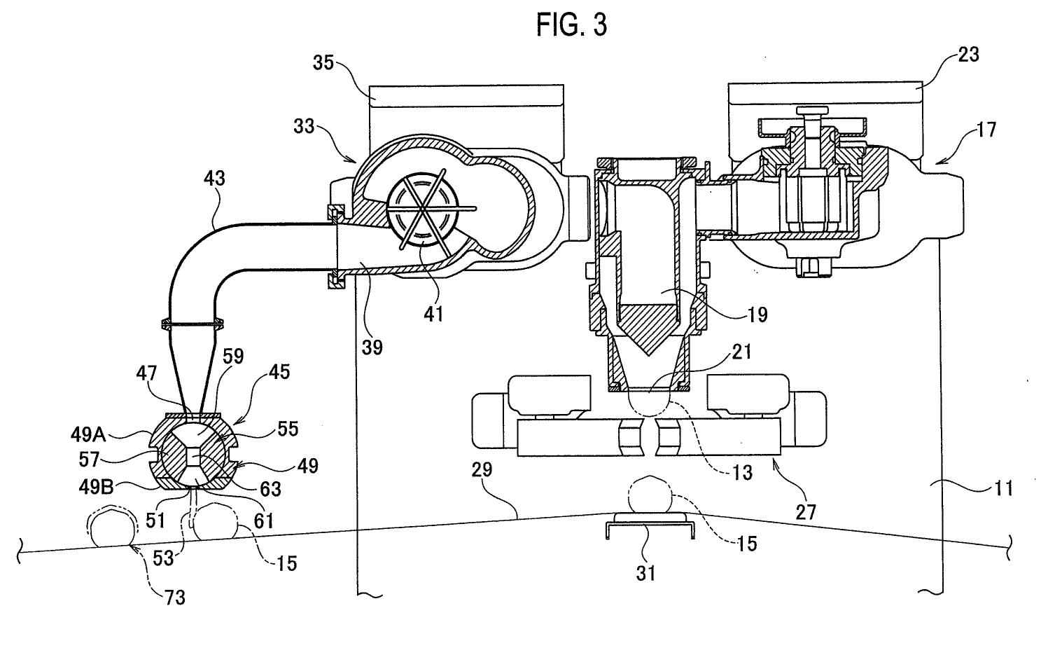

The pastry producing apparatus 3 includes a box-shaped frame 11, and includes a core dough cutting apparatus 17 above the frame 11. Then, the core dough cutting apparatus 17 cuts the first food dough 13 (refer to FIG. 3) such as the bread dough into the core dough 15 with the desired shape, for example, such as a spherical shape. The core dough cutting apparatus 17 is composed by closing a discharge port for either one of a filling material and an outer shell material in an envelope cutting apparatus already known in Japanese Patent Laid-Open No. 2004-129524. Specifically, as shown in FIG. 3, the core dough cutting apparatus 17 has a configuration in which a discharge port 19 of the envelope cutting apparatus, the discharge port 19 discharging the filling material, is closed. Other portions have configurations well known in the envelope cutting apparatus.

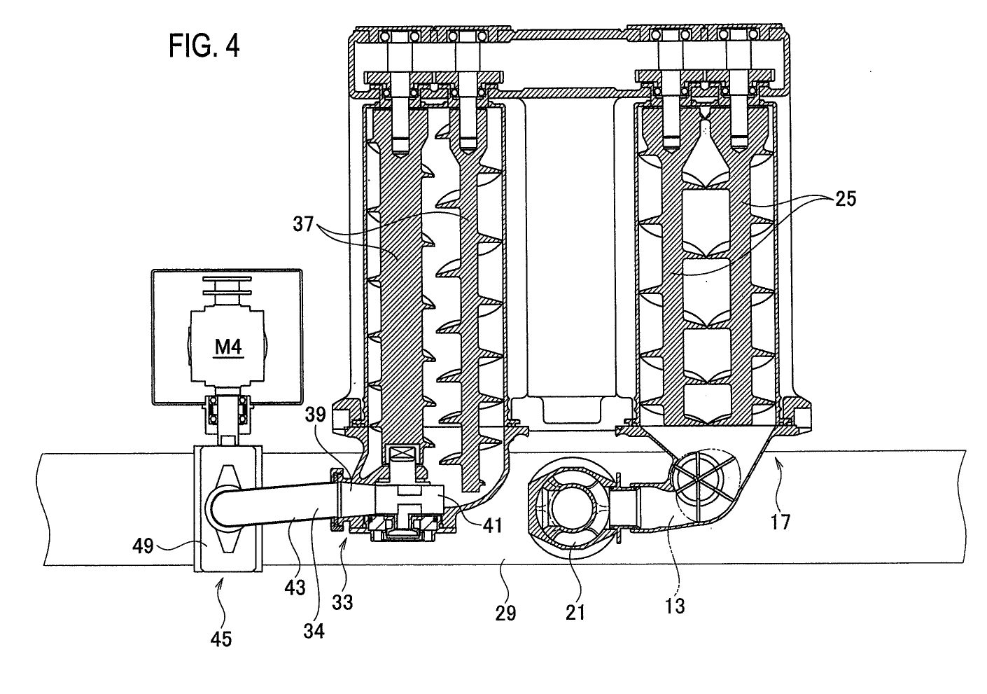

As mentioned above, the entire configuration of the core dough cutting apparatus 17 is already known in public in the envelope cutting apparatus. This configuration is schematically shown in FIGS. 3 and 4. In a similar way to the envelope cutting apparatus known in public, the core dough cutting apparatus 17 rotatably includes a pair of screws 25 (refer to FIG. 4) as a food dough supply section under a hopper 23 (refer to FIG. 1), which houses the first food dough therein, in order to feed the first food dough such as the bread dough to a discharge port 21 that discharges the first food dough concerned. The screws 25 are rotated by a motor M1 (not shown) mounted on the above-described frame 11.

When the motor M1 rotates the screws 25, the food dough in the hopper 23 is fed to the discharge port 21. The food dough concerned is discharged downward from the discharge port 21 continuously in a bar shape that is circular in cross section. Then, the bar-shaped food dough is cut into the core dough 15 with the desired shape such as the spherical shape and the long bar shape by a shutter apparatus 27 that is vertically movable and openable/closable and is already known in public in the envelop cutting apparatus.

As already known in the envelope cutting apparatus, at a position below the shutter apparatus 27, a conveyor belt 29 as a core dough conveying apparatus that is vertically movable in order to receive the core dough 15 and is capable of freely conveying the core dough 15 to the downstream side (left side in FIG. 3) is provided so as to be runnable. Then, at a position below the discharge port 21, a vertically moving member 31 for vertically moving the conveyor belt 29 is provided. As known in the envelope cutting apparatus, this vertically moving member 31 is vertically moved in synchronization with vertical movement of the shutter apparatus 27. Note that the conveyor belt 29 is allowed to run rotating at a constant speed by a motor M2 (not shown).

At a position that is on an upper portion of the frame 11 and adjacent to the core dough cutting apparatus 17, an overlying dough supply apparatus 33 is provided. The overlying dough supply apparatus 33 places flat (sheet-shaped) overlying dough as the second food dough, for example, such as biscuit dough on an upper portion of the core dough 15 conveyed to the downstream side by the conveyor belt 29. Moreover, in a similar way to the core dough cutting apparatus 17, the overlying dough supply apparatus 33 includes a pair of screws 37 (refer to FIG. 4) as a food dough supply section under a hopper 35 (refer to FIG. 1) that houses the second food dough 34 therein. Then, at a position close to an outlet port 39 of the food dough sent by the screws 37, a vane pump 41 interlocked and coupled to one of the screws 37 is provided. Note that the screws 37 are rotated by a motor M3 (not shown) distinct from the motor M2.

One end side of a pipe 43 is connected to the outlet port 39. To the other end side of the pipe 43, a discharge apparatus 45 for the sheet-shaped food dough is connected. The discharge apparatus 45 is provided for forming the second food dough 34, which is fed with pressure from the above-described food supply section, into the flat (sheet) shape and discharging the flat second food dough 34 concerned.

The discharge apparatus 45 for the sheet-shaped food dough includes a cylindrical casing 49 in which an inlet port 47 communicating with the pipe 43 is formed. The casing 49 is split into: an upper-side body portion 49A including the inlet port 47; and a lower-side nozzle portion 49B including a longitudinally slit-shaped opening portion 51. The nozzle portion 49B is provided on the body portion 49A while interposing fasteners such as bolts (not shown) therebetween so as to be detachable therefrom and replaceable by others. Hence, the nozzle portion 49B is replaced, whereby a slit width of the opening portion 51 is changeable into a variety of dimensions. From this matter, a thickness of the sheet-shaped food dough (overlying dough) 53 (refer to FIG. 3) discharged from the opening portion 51 can be changed in various ways.

Note that, in the case where it is not necessary to change the thickness of the overlying dough 53, a configuration may be adopted, in which the body portion 49A and the nozzle portion 49B are integrated in advance with each other.

A rotary valve 55 rotated by a motor M4 (refer to FIG. 4) is rotatably mounted in an inside of the casing 49 of the discharge apparatus 45. The rotary valve 55 includes a receiving opening portion 59 in an upper portion side on a circumferential surface of a valve body 57 thereof. The receiving opening portion 59 is always in a communicating state with the inlet port 47, and receives the second food dough 34 fed with pressure from the food dough supply section composed of the screws 37, the vane pump 41 and the like.

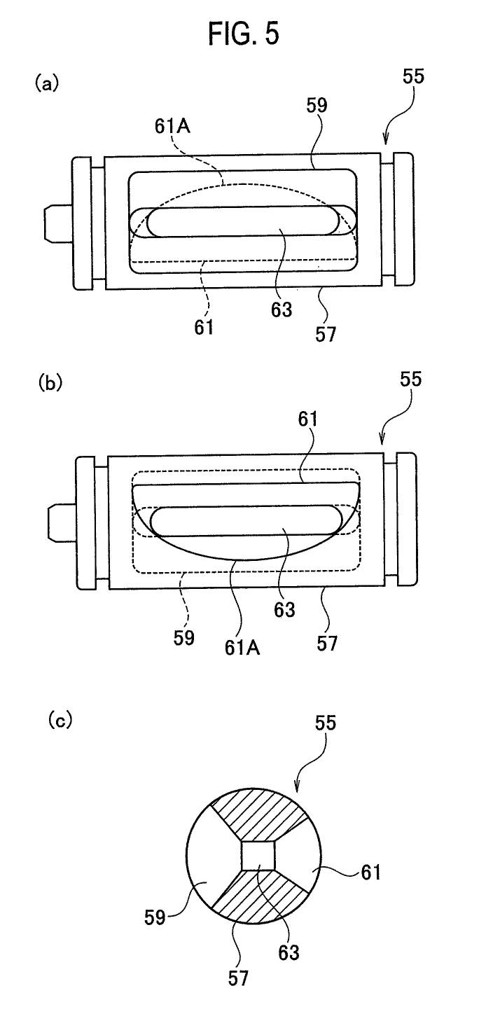

Then, in a lower portion side of the valve body 57, an outlet opening portion 61 for guiding the received food dough to the slit-shaped opening portion 51 side is formed. Moreover, a throttle portion 63 is formed between the receiving opening portion 59 and the outlet opening portion 61. A circumferential edge of the outlet opening portion 61 is formed into a substantially semicircular shape on a circumferential surface of the valve body 57. To be more specific, as shown in FIG. 5, in the outlet opening portion 61, a shape of an opening edge 61A having a curved edge is formed so as to include a curved edge in which a dimension in a circumferential direction, which reaches the opening edge 61A from a virtual reference position on a circumferential surface of the valve body 57, the virtual reference position being parallel to an axial center thereof, becomes gradually shorter toward both end sides in a longitudinal direction of the valve body 57 from a center portion side therein.

Note that the shape of the opening edge 61A is not limited to the shape as described above, which includes the curved edge, and for example, may be made into a trapezoidal shape. In this case, it is also possible to adopt appropriately modified forms, for example, by making corner portions of such a trapezoid into arc-shaped curved edges, making linear portions of the trapezoid into protruding curved edges, and so on.

With the above-described configuration, the second food dough 34 is fed with pressure from the food dough supply section such as the screws 37 and the vane pump 41 to the discharge apparatus 45. Then, the second food dough 34 passes through the receiving opening portion 59, throttle portion 63 and outlet opening portion 61 of the rotary valve 55, and is discharged as the sheet-shaped (flat) food dough (overlying dough) 53 from the slit-shaped opening portion 51. At this time, timing when the core dough 15 conveyed by the conveyor belt 29 reaches a position below the discharge apparatus 45 is taken, and start and stop of the discharge of the sheet-shaped dough 53 are performed by the rotation of the rotary valve 55. From this matter, the sheet-shaped dough (overlying dough) 53 with an appropriate size is placed on the core dough 15. Specifically, a pastry in which the overlying dough 53 is just placed on the core dough 15 is produced.

Hence, in the case of performing, as a subsequent step, a step of forming the upper surface of the pastry into a shape having a curved surface by handwork, a step of placing the overlying dough 53 on the core dough 15 by handwork can be omitted. In such a way, small amount production by handwork can also be easily coped with.

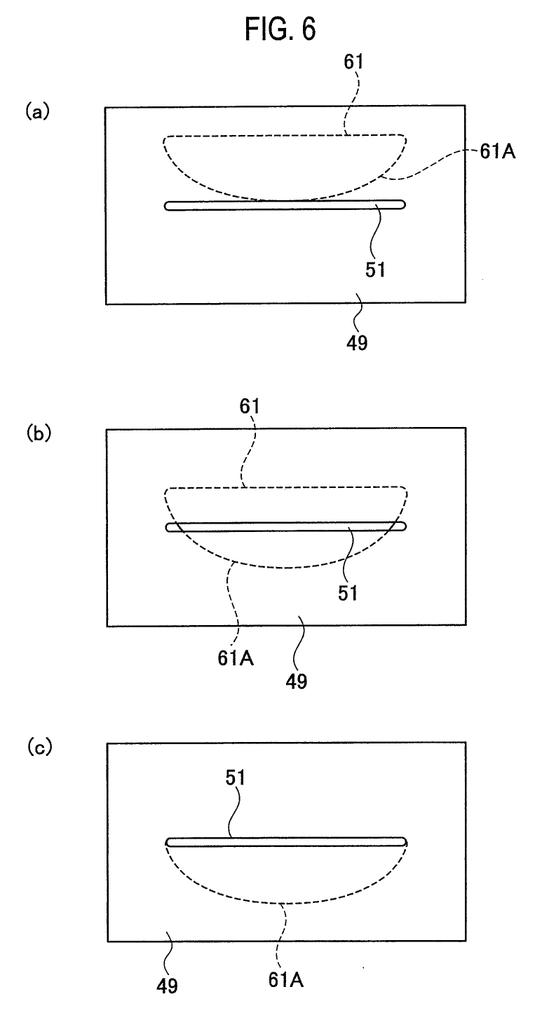

Moreover, when the rotary valve 55 is normally rotated relatively to the slit-shaped opening portion 51 of the casing 49, as shown in FIG. 6(a), the opening edge 61A of the outlet opening portion 61 starts to intersect the opening portion 51 so as to transverse the opening portion 51 concerned. At this time, the discharge of the sheet-shaped food dough 53 is started from the opening portion 51. When the normal rotation of the rotary valve 55 gradually advances, as shown in FIGS. 6(b) and 6(c), an interval between positions where the opening edge 61A intersects the opening portion 51 is gradually increased. Then, a width dimension of the sheet-shaped food dough 53 discharged from the opening portion 51 is gradually increased.

Then, after the rotary valve 55 is normally rotated so that the interval between the intersection points of the opening edge 61A to the opening portion 51 can be gradually increased, the rotary valve 55 is reversely rotated so that the interval between the intersection points can be gradually reduced. In such a way, the shape of the sheet-shaped food dough 53 discharged from the opening portion 51 is formed, for example, into a circular shape. Moreover, when the rotary valve 55 shifts from the normal rotation to the reverse rotation, the rotary valve 55 is temporarily held in a stop state. In such a way, it becomes possible to form the sheet-shaped food dough 53 into an elliptical or oval shape so as to correspond to the shape of the core dough 15. At this time, a normal rotation range of the rotary valve 55 is controlled as appropriate, whereby the width dimension of the sheet-shaped food dough 53 is changed in various ways. Specifically, the size of the overlying dough 53 is adjusted so as to correspond to the shape and size of the core dough 15.

As mentioned above, the slit-shaped opening portion 51 and the opening edge 61A of the outlet opening portion 61 in the rotary valve 55 intersect each other, whereby the sheet-shaped food dough 53 is discharged from the opening portion 51. At this time, since the throttle portion 63 is formed in the rotary valve 55, the food dough fed with pressure from the food dough supply section composed of the screws 37, the vane pump 41 and the like is in a high pressure state in the receiving opening portion 59 located on an upstream side of the throttle portion 63. Then, the food dough that has reached the outlet opening portion 61 through the throttle portion 63 passes through the throttle portion 63 and is in a state where the pressure thereof is released, and accordingly, is held at a lower pressure than the pressure of the food dough in the receiving opening portion 59.

Specifically, the sheet-shaped food dough 53 passes through the throttle portion 63, is held at such a low pressure where the pressure thereof is released, and is discharged from the opening portion 51. Hence, an inner stress of the sheet-shaped food dough 53 is smaller as compared with a case where the sheet-shaped food dough 53 is directly discharged from the opening portion 51 while keeping the state of being fed with pressure from the food dough supply section. This suppresses a phenomenon that the sheet-shaped food dough 53 changes the shape thereof and so on owing to the inner stress after discharged from the opening portion 51.

As mentioned above, when the second food dough 34 is discharged in the sheet shape from the opening portion 51, the pressure in the outlet opening portion 61 in the rotary valve 55 is held to be lower than the pressure in the opening portion 59 therein. However, in the case where the opening portion 51 is in a state of being closed by the rotary valve 55, when the food dough is fed with pressure from the food dough supply section in advance, the food dough in the outlet opening portion 61 turns to the high pressure state. When the food dough is in such a high pressure state, if an opening operation for the opening portion 51 is started by the rotation of the rotary valve 55, then the food dough is suddenly discharged from the opening portion 51, and this is not desirable.

Accordingly, in this embodiment, in order to prevent the pressure of the food dough in the outlet opening portion 61 from rising more than necessary, a controller 65 (refer to FIG. 1) performs control so that the supply start of the food dough supply section composed of the screws 37, the vane pump 41 and the like and the opening operation for the opening portion 51 by the normal rotation of the rotary valve 55 can be performed simultaneously. Meanwhile, the controller 65 performs control so that the closing operation for the opening portion 51 by the reverse rotation of the rotary valve 55 and the supply stop of the food dough supply section can be performed simultaneously.

Hence, the inner stress of the sheet-shaped food dough 53 discharged from the opening portion 51 is suppressed, and the second food dough 34 is suppressed from being suddenly discharged from the opening portion 51. In such a way the sheet-shaped food dough 53 is stably discharged.

Note that operations related to the sheet dough supply operation in the overlying dough supply apparatus 33, which are the cutting operation of the core dough cutting apparatus 17, the vertical operation of the conveyor belt 29 and the conveying operation of the conveyor belt 29 in the pastry producing apparatus 3, are controlled in such a manner that the rotations of the motors individually corresponding thereto are controlled by the controller 65. Specifically, the related operations controlled in order to place the sheet-shaped food dough 53 on the core dough 15 that has been cut at every predetermined time and has reached the discharge apparatus 45 for the sheet-shaped food dough 53 are concerned, for example, with timing to start the normal rotation of the valve body 57 by the motor M4 and timing to start the rotation of the screws 37 simultaneously therewith, rotation speed and angles at the time of the normal rotation of the valve body 57 and the time of the reverse rotation thereof which are for adjusting the size of the sheet-shaped food dough 53, a stop time in the event where the rotation of the valve body 57 changes from the normal rotation to the reverse rotation, timing to start the reverse rotation of the valve body 57, timing to stop the motor M4 and the screws 37 when the discharge of the sheet-shaped food dough 53 is ended, and the like. In other words, the related operations are operations for covering the core food dough 15 with the sheet-shaped food dough 53.

In the pastry producing apparatus 3, on a downstream side of the discharge apparatus 45, a powder applicator 67 is detachably provided. As mentioned above, the powder applicator 67 applies dusting powder such as flour and dusting powder of granulated sugar on the pastry in the state where the sheet-shaped food dough 53 is placed on the core dough 15. This type of powder applicator 67 is known in public, and is also capable of omitted depending on the case. Hence, a detailed description of the powder applicator 67 is omitted. Below the powder applicator 67, a conveyor belt 29A on a downstream end side of the conveyor belt 29 is provided so as to be foldable downward from a horizontal state through a conveyor plate.

The second unit U2 includes a box-shaped frame 69. On this frame 69, the upper curved surface forming apparatus 5, shaping apparatus 7, and imprinting apparatus 9 are sequentially mounted from the upstream side (right side of FIG. 1) to the downstream side (left side of FIG. 1). Then, in the frame 69, there are provided: a conveyor belt 71A corresponding to the upper curved surface forming apparatus 5; a conveyor belt 71B corresponding to the shaping apparatus 7; and a conveyor belt 71C corresponding to the imprinting apparatus 9. These conveyor belts are provided so as to be rotated by motors distinct from one another, and to be capable of freely running rotating individually.

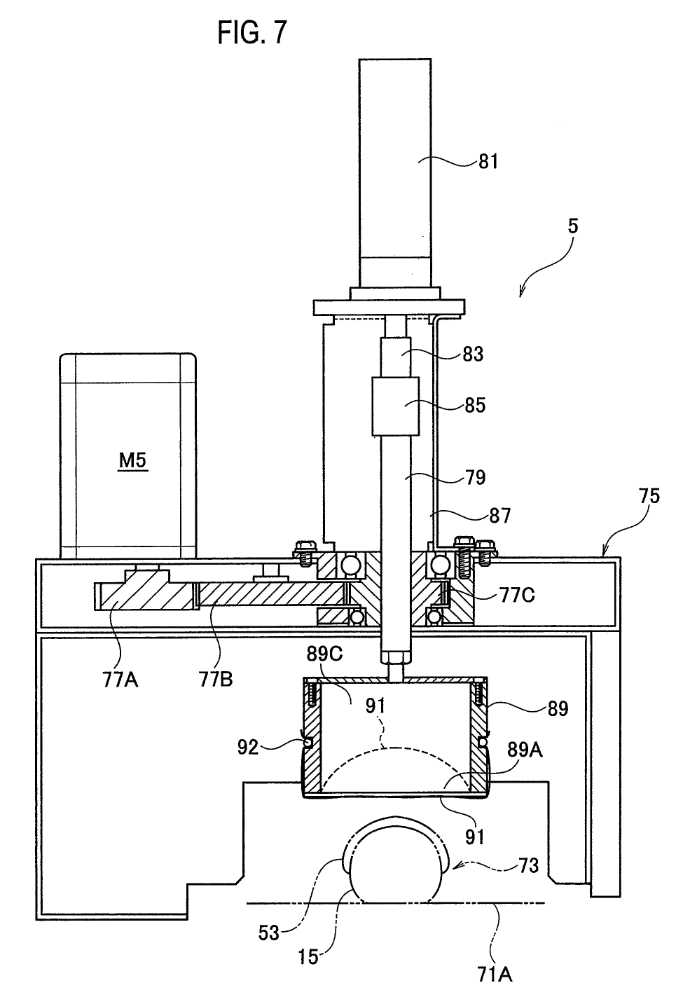

As shown in FIG. 7, the upper curved surface forming apparatus 5 includes a mount 75 mounted on the frame 69, and forms an upper surface of a pastry 73 in the state where the sheet-shaped dough 53 is placed on the core dough 15 into a curved surface shape. A motor M5 is attached to the mount 75, and a drive gear 77A provided on an output shaft of the motor M5 supports, so as to be rotatable, a gear 77C interlocked and coupled thereto while interposing an intermediate gear 77B therebetween. Then, in an axial center portion of the gear 77C, a rotating shaft 79 is provided so as to be vertically movable.

The above-described rotating shaft 79 is configured so as to rotate integrally with the gear 77C while interposing, for example, a sliding key or the like therebetween, but to be vertically movable relatively to the gear 77C. An upper end portion of the rotating shaft 79 is coupled to a vertically operating rod 83, which is provided on a vertically moving actuator 81 such as an air cylinder so as to be vertically movable, while interposing a rotation joint 85 therebetween. The upper end portion is coupled to the vertically moving rod 83 so as to be rotatable relatively thereto. Note that the vertically moving actuator 81 is mounted on the mount 75 while interposing a bracket 87 therebetween.

Then, to a lower end portion of the rotating shaft 79, a cylindrical forming cup 89 is attached integrally therewith. The forming cup 89 includes a recessed portion 89C, which is circular in cross section, in order to form the upper surface of the pastry 73 into the hemispherical shape. Then, on an opening portion 89A opening to a lower side of the forming cup 89, a textile fabric 91 that is stretchable and has no adhesiveness is detachably extended by a holding tool 92 such as an O-ring. The textile fabric 91 is a knitted or textile fabric of fiber having a configuration in which fluorine-treated yarn is wound around extensible polyurethane elastic fiber (Spandex), and is excellent in stretchability, non-adhesiveness of food, and low frictional properties.

With the configuration described above, the pastry 73 is carried from the pastry producing apparatus 3 onto the conveyor belt 71A of the upper curved surface forming apparatus 5. Then, the pastry 73 is positioned at a position below the forming cup 89. Then, the forming cup 89 is rotated by the motor M5, and is fallen down by actuation of the vertically moving actuator 81. Hence, the textile fabric 91 extended on the opening portion 89A of the forming cup 89 is pressed against the pastry 73 while rotating. In such a way, intimate contact between the core dough 15 and the sheet-shaped food dough 53 is achieved. Moreover, at this time, the textile fabric 91 is extended, and is gradually curved as shown by a dotted line in FIG. 7. In such a way, the pastry 73 is formed into the hemispherical shape. In this event, since the textile fabric 91 is stretchable, has no adhesiveness, and is excellent in low frictional properties, the pastry 73 does not adhere to the textile fabric 91. Therefore, the surface of the pastry 73 is formed into a good hemispherical shape that is smooth.

Incidentally, in the case where the pastry 73 has the long bar shape as mentioned above, it is not necessary to rotate the rotating shaft 79 in the upper curved surface forming apparatus 5. In this case, a configuration just needs to be adopted, in which the shape of the opening portion 89A of the recessed portion provided in the forming cup 89 is formed into an elliptical or rectangular shape corresponding to the shape of the pastry 73, and the textile fabric 91 is extended on the opening portion 89A. Then, the forming cup 89 falls down, and presses the textile fabric 91 against the pastry 73 from upward. In such a way, the textile fabric 91 is stretched and curved, and forms a curved surface on the upper surface of the pastry 73.

Note that, in the above-described configuration, it is desirable to adopt a configuration, in which an orientation of the forming cup 89 is constantly maintained, and the rotating shaft 79 rotates slightly eccentrically, as a configuration in which the forming cup 89 is provided so as to be eccentrically rotatable with respect to the rotating shaft 79. By adopting such a configuration, the textile fabric 91 causes slight slippage with the pastry 73, and the surface of the pastry 73 is finished into a smoother surface.

As shown in FIG. 2, the shaping apparatus 7 includes a guide plate 93, which is extended in parallel to a conveying direction of the pastry by the conveyor belt 71B, so that a position of the guide plate 93 can be adjustable in a width direction of the conveyor belt 71B. Moreover, at a position opposite to the guide plate 93, a belt 95 for sandwiching the pastry 73 with the guide plate 93 and rolling the pastry 73 in the downstream direction is provided.

With the above-described configuration, the pastry 73 carried onto the conveyor belt 71B is lightly sandwiched by the guide plate 93 and the belt 95 in the horizontal direction. Then, by a motor M6, the belt 95 is allowed to run rotating in a counterclockwise direction of FIG. 2. In such a way, the pastry 73 rolls relatively to the guide plate 93, and moves to the downstream side. As described above, when the pastry 73 rolls so as to rotate about a perpendicular axis center thereof, the core dough 15 is brought into intimate contact with the sheet-shaped dough 53. In such a way, the pastry 73 is subjected to the shaping action on a peripheral surface thereof, and the peripheral surface is subjected to finish shaping into a peripheral surface free from irregularities.

The description has been made thus far of the case where the configuration of the shaping apparatus 7 is ready for the hemispherical pastry 73. Next, a description will be made of the case where the pastry 73 has the long bar shape as mentioned above. In this case, a configuration is adopted, in which a belt distinct from the belt 95 is arranged symmetrically (in an opposite arrangement fashion) thereto in place of the guide plate 93. Then, the pastry 73 is lightly sandwiched by the belt 95 and the distinct belt, and is conveyed to the downstream side. In such a way, the sheet-shaped dough 53 and the core dough 15 are brought into intimate contact with each other and are shaped well. Note that, in place of the configuration in which the belt 95 and the distinct belt are arranged opposite to each other, it is also possible to adopt a configuration in which a pair of hard rollers are arranged.

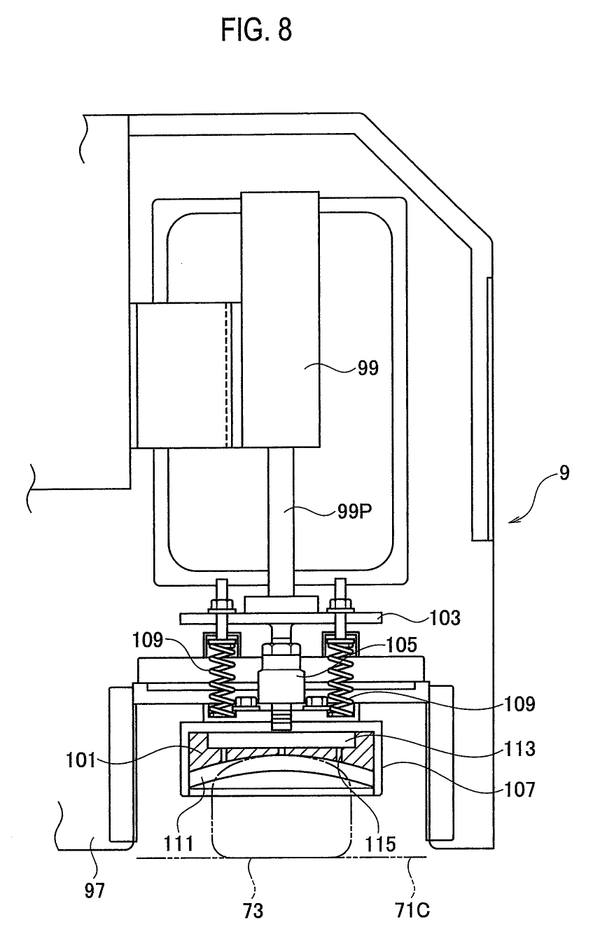

Next, the pastry 73 subjected to the shaping action in the shaping apparatus 7 is carried into the imprinting apparatus 9, and an appropriate groove-shaped pattern is formed on an upper portion thereof. To be more specific, as shown in FIG. 8, the imprinting apparatus 9 includes a mount 97 mounted on the frame 69. Then, on the mount 97, a vertically moving actuator 99 such as an air cylinder is mounted. The vertically moving actuator 99 includes a vertically operating rod 99P such as a piston rod so as to be vertically movable. Then, a template 101 is provided on a lower end portion of the vertically operating rod 99P.

To be more specific, on a center portion of a lower surface of a support plate 103 horizontally attached integrally with a lower end portion of the vertically operating rod 99P, a housing 107 that is a cylinder having a bottom is swingably supported while interposing an appropriate universal joint 105, for example, such as a ball joint therebetween. Then, on the periphery of the universal joint 105, at plural spots (four spots in this example) between the support plate 103 and an upper surface of the housing 107, elastic members 109, for example, such as compression springs are elastically mounted as urging devices. In such a way, downward urging forces by the respective elastic members 109 are balanced, and the housing 107 is held in a horizontal posture as a basic posture.

Into the housing 107, the template 101 is attached detachably and replaceably. On a lower surface of the template 101, a template surface 111 on a surface of which uneven portions are formed. The template surface 111 imprints the appropriate pattern such as a pattern in which grooves intersect one another to the upper portion of the pastry 73. The pattern concerned includes: a shell pattern, for example, such as a pattern on an upper portion of the concha; and a pattern on the upper portion of the melonpan. Then, on the template 101, an air chamber 113 for reserving therein air supplied from an air supply device (not shown) is provided. A plurality of air jets 115 with a small diameter, which are open to the template surface 111, are allowed to communicate with the air chamber 113.

With the above-described configuration, the pastry 73 is carried from the shaping apparatus 7 onto the conveyor belt 71C of the imprinting apparatus 9, and is positioned below the template 101. Then, the housing 107 is fallen down by actuation of the vertically moving actuator 99, and the template surface 111 of the template 101 is pressed against the upper portion of the pastry 73. In such a way, the pattern of the template surface 111 is imprinted to the upper portion of the pastry 73.

In this event, the housing 107 is swingably supported, and is supported in a state of being pressed and urged downward through the plurality of elastic members 109. In such a way, even in the case where an axial center of the pastry 73 and an axial center of the housing 107 somewhat deviate from each other, the pattern of the template surface 111 is imprinted to the upper portion of the pastry 73 without causing any problem.

Then, when the housing 107 rises, the air is supplied from the air supply device into the air chamber 113, and the air is jetted to the template surface 111 from the air jets 115 at the plural spots. In such a way, an air layer is formed between the template surface 111 and the upper surface of the pastry 73. Therefore, the pastry 73 is easily peeled off from the template surface 111.

Moreover, it is also possible to use only the upstream unit U1 for producing the pastry, and to perform subsequent rounding work and shaping work for the pastry 73 by handwork. In such a way, it is also possible to easily cope with the small amount production of the pastry in which the core dough 15 is covered with the sheet-shaped dough 53. Moreover, a line configuration in which the melonpan as the pastry is produced can be established, by combining the upstream unit U1 and the downstream unit U2 with each other. Hence, versatility of the production line in the event of producing the pastry is enhanced.

Furthermore, the inner stress of the sheet-shaped food dough 53 that covers the core dough 15 can be reduced as compared with the case where the sheet-shaped food dough 53 is discharged while keeping the state of being fed with pressure from the food dough supply section. In such a way, equalization of the sheet-shaped dough 53 is achieved.

Moreover, in the upper curved surface forming apparatus 5, the textile fabric 91 that is stretchable and has no adhesiveness is used. Therefore, when the textile fabric 91 returns to an original planar state thereof after forming the upper surface of the pastry 73 into the curved surface shape, the textile fabric 91 and the pastry 73 are effectively peeled off from each other. In such a way, enhancement of productivity is enhanced.

In a similar way, in the imprinting apparatus 9, the air layer is formed between the template surface 111 of the template 101 and the pastry 73, whereby the pastry 73 is effectively peeled (separated) from the template surface 111. In such a way, the enhancement of the productivity is enhanced.

1. A pastry producing apparatus for producing a pastry that is in a state where overlying dough is placed on core dough, comprising:
a core dough cutting apparatus for cutting first food dough into the core dough with a desired shape;
a core dough conveying apparatus that is vertically movable in order to receive the core dough and is capable of conveying the core dough to a downstream side;
an overlying dough supply apparatus provided adjacent to the core dough cutting apparatus in order to place the overlying dough to be flatten as second food dough on the core dough conveyed by the core dough conveying apparatus; and
an operation controller for controlling an overlying dough supply operation of the overlying dough supply apparatus operating in relation to a cutting operation of the core dough cutting apparatus and vertical and conveying operations of the core dough conveying apparatus.

2. The pastry producing apparatus of claim 1, wherein
the overlying dough supply apparatus rotatably includes a rotary valve capable of adjusting a discharge width of the overlying dough in a casing including a slit-shaped opening portion for forming, into a flat shape, the second food dough fed with pressure from a food dough supply section supplying the second food dough, the overlying dough discharged from the opening portion.

3. The pastry producing apparatus of claim 2, wherein
the rotary valve includes a receiving opening portion for receiving the second food dough fed with pressure from the food dough supply section in a part of a circumferential surface of a valve body, and includes an outlet opening portion for guiding the food dough to the slit-shaped opening portion side in a part of the circumferential surface of the valve body, and
the outlet opening portion includes an opening edge having a curved edge in which a dimension in a circumferential direction from a virtual reference position on the circumferential surface, the virtual reference position being parallel to an axial center of the valve body, becomes gradually shorter toward both end sides in a longitudinal direction of the valve body from a center portion side in the longitudinal direction, or the outlet opening portion includes an opening edge with a trapezoidal shape.

4. The pastry producing apparatus of claim 2, wherein
timing when the food dough supply section starts to feed the second food dough with pressure and timing when the rotary valve opens the slit-shaped opening portion are substantially the same.

5. A pastry producing line using the pastry producing apparatus of claim 1, comprising:
the pastry producing apparatus;
an upper curved surface forming apparatus for pressing the overlying dough against the core dough, thereby forming the overlying dough and the core dough integrally with each other as a pastry, and forming an upper surface of the pastry into a curved surface shape, the upper curved surface forming apparatus provided on a downstream side of the pastry producing apparatus;
a shaping apparatus for horizontally moving the pastry in which the upper surface is formed into the curved surface shape by the upper curved surface forming apparatus, and performing a shaping action for the pastry, the shaping apparatus provided on a downstream side of the upper curved surface forming apparatus; and
a imprinting apparatus for pressing a template against an upper portion of the pastry subjected to the shaping action by the shaping apparatus, and imprinting, to the upper portion, an appropriate groove-shaped pattern provided in the template, the imprinting apparatus provided on a downstream side of the shaping apparatus.

6. The pastry producing line of claim 5, wherein
the imprinting apparatus includes a plurality of air jets which jet air into an inner surface of the template in order to peel off the pastry from the template.

7. The pastry producing line of claim 5, wherein
the template provided in the imprinting apparatus has a configuration that is urged by a plurality of urging devices so as to hold a basic posture, and is swingable at a time of pressing the pastry.

8. The pastry producing line of claim 5, wherein
the pastry producing apparatus composes one unit, and
the upper curved surface forming apparatus, the shaping apparatus and the imprinting apparatus compose one unit in combination with one another.
